(19) United States
(12) Patent Application Publication
(10) Pub. No.: US 2023/0011307 A1
(43) Pub. Date: Jan. 12, 2023

(54) METHOD FOR PRODUCING AND CLASSIFYING POLYCRYSTALLINE SILICON

(71) Applicant: WACKER CHEMIE AG, Munich (DE)

(72) Inventors: Thomas Schröck, Kastl (DE); Markus WENZEIS, Wurmannsquick (DE)

(73) Assignee: Wacker Chemie AG, Munich (DE)

(21) Appl. No.: 17/781,410

(22) PCT Filed: Dec. 17, 2019
(86) PCT No.: PCT/EP2019/085569

§ 371 Date: Jun. 1, 2022

(51) Int. Cl. C01B 33/035; G06V 10/764

(52) U.S. Cl. CPC C01B 33/035; G06V 10/764

(57) ABSTRACT

A method for producing and classifying polycrystalline silicon. The method includes producing polycrystalline silicon rod within a reaction space of a gas phase deposition reactor by introducing a reaction gas, which in addition to hydrogen contains silane and/or at least one halosilane. Once produced, the polycrystalline silicon rod is extracted from the reactor, and at least one two-dimensional and/or three-dimensional image is generated of at least one partial region of the polycrystalline silicon rod or of at least one silicon chunk created. At least one analysis region is selected per generated image and at least two surface-structure indices per analysis region are generated by using image processing methods, each of which is generated using a different image processing method. The surface-structure indices are combined to form a morphology index.

The invention relates to a method for producing and classifying polycrystalline silicon, wherein the polycrystalline silicon is classified depending on a morphology index determined on the basis of two- and/or three-dimensional images and is sent to different processing steps.

Polycrystalline silicon (polysilicon) serves as a starting material in the production of single-crystal (monocrystalline) silicon, for example by means of crucible pulling (Czochralski or CZ process) or by means of zone melting (float zone process). Single-crystal silicon is used in the semiconductor industry for the manufacture of electronic components (chips).

Polysilicon is also needed for the production of multicrystalline silicon, for example by means of block casting processes. The multicrystalline silicon, obtained in the form of a block, can be used for the manufacture of solar cells.

Polysilicon can be obtained by the Siemens process—a chemical vapour deposition process. This involves heating support bodies in a bell-shaped reactor (Siemens reactor) by way of the direct passage of current and introducing a reaction gas comprising a silicon-containing component and hydrogen. The silicon-containing component is generally monosilane (SiH₄) or a halosilane of the general composition SiHₙX₄₋ₙ (n=0, 1, 2, 3; X=Cl, Br, I). It is typically a chlorosilane or a chlorosilane mixture, usually trichlorosilane (SiHCl₃, TCS). Predominantly, SiH₄ or TCS is used in a mixture with hydrogen. The structure of a typical Siemens reactor is described for example in EP 2 077 252 A2 or EP 2 444 373 A1. The bottom of the reactor (bottom plate) is generally provided with electrodes that receive the support bodies. The support bodies are customarily filament rods (thin rods) made of silicon. Typically, two filament rods are connected via a bridge (made of silicon) to form a rod pair that forms a circuit via the electrodes. The surface temperature of the filament rods during the deposition is typically more than 1000° C. At these temperatures, the silicon-containing component of the reaction gas decomposes and elemental silicon is deposited from the vapour phase as polysilicon. The diameter of the filament rods and of the bridge increases as a result. After reaching a predetermined diameter of the rods, the deposition is stopped and the polysilicon rods obtained are extracted. After removal of the bridge, approximately cylindrical silicon rods are obtained.

The morphology of the polysilicon, or more precisely the polysilicon rods and the chunks produced from these, generally has a strong influence on the performance during further processing. The morphology of a polysilicon rod is fundamentally determined by the parameters of the deposition process (e.g. rod temperature, silane and/or chlorosilane concentration, specific flow rate). Depending on the parameters, pronounced interfaces, up to and including holes and trenches, can form. These are generally not distributed homogeneously inside the rod. What is more, polysilicon rods having various (usually concentric) morphological regions can form as a result of variation of the parameters, as has been described by way of example in EP 2 662 335 A1. The dependence of the morphology on the rod temperature is brought up for example in US 2012/0322175 A1.

The morphology of polysilicon can range from compact and smooth to very porous and fissured. Compact polysilicon is substantially free from cracks, pores, joints and fissures. The apparent density of polysilicon of this type can be equated to the true density of silicon or at least corresponds to this to a good approximation. The true density of silicon is 2.329 g/cm³.

A porous and fissured morphology, i.e. a highly pronounced morphology, has negative consequences in particular on the crystallization behaviour of polysilicon. This is particularly apparent in the CZ process for producing single-crystal silicon. Here, the use of fissured and porous polysilicon leads to economically unacceptable yields. In the CZ process, particularly compact polysilicon generally leads to markedly higher yields. However, the production of compact polysilicon is usually more costly since a slower deposition process is needed. In addition, not all applications require the use of particularly compact polysilicon. For example, the morphology requirements when producing multicrystalline silicon by the block casting process are much lower.

Accordingly, polysilicon is distinguished and classified not only according to purity and chunk size but also according to its morphology. Since various parameters can be subsumed under the term “morphology”, such as for example porosity (sum of closed and open porosity), specific surface area, roughness, gloss and colour, reproducible determination of the morphology presents a great challenge. A visual assessment of the polysilicon rods or chunks after the deposition by a person, that is to say the forming of a personal impression of quality, as proposed in WO 2014/173596 A1, not only has the disadvantages of a lack of reproducibility and accuracy but also has the disadvantage of a low throughput. It is typically only possible to classify whole polysilicon rods or at a minimum large rod sections on the basis of personal impressions of quality. In normal operation, monitoring can also only be performed on the basis of random samples.

The object of the invention was to provide a method for determining the morphology of polysilicon after deposition in order in particular to make subsequent processing of the polysilicon more efficient.

This object is achieved by a method for producing and classifying polysilicon, comprising the following steps:
producing at least one polycrystalline silicon rod by introducing a reaction gas, which in addition to hydrogen contains silane and/or at least one halosilane, into a reaction space of a gas phase deposition reactor, wherein the reaction space contains at least one heated filament rod upon which silicon is deposited to form the polycrystalline silicon rod,
extracting the silicon rod from the reactor,
optionally comminuting the silicon rod to obtain silicon chunks,
generating at least one two-dimensional (2D) and/or three-dimensional (3D) image of at least one partial region of the silicon rod or of at least one silicon chunk, and selecting at least one analysis region per generated image,
generating at least two surface-structure indices per analysis region by means of image processing methods, each surface-structure index being generated using a different image processing method,
combining the surface-structure indices to form a morphology index.

The silicon rods or the silicon chunks are classified depending on the morphology index and are sent to different processing steps.

As described at the outset, polysilicon with varying morphology can form depending on the deposition parameters, wherein regions of differing morphology which are separated from each other by interfaces can also occur within the same polysilicon rod, in particular in the radial direction of the cross-sectional area thereof. Morphology is to be understood here in particular to mean the degree of fissuring in the polysilicon resulting from the frequency and arrangement of holes, pores and trenches. The morphology can also be understood to be the porosity of the polysilicon.

During the deposition, the formation of pores and trenches is apparent from a surface structure which is reminiscent of popcorn. In profile, a so-called popcorn surface is an accumulation of elevations (peaks) and trenches (valleys).

The number of filament rods/silicon rods arranged in the gas phase deposition reactor is generally unimportant for the execution of the method according to the invention. The gas phase deposition reactor is preferably a Siemens reactor as described in the introduction and for example in EP 2 662 335 A1. The filament rod is preferably one of two thin rods made of silicon which are connected via a bridge made of silicon to form a rod pair, the two free ends of the rod pair being connected to electrodes at the reactor bottom. Many more than two filament rods (one rod pair) are generally arranged in the reactor space. Typical examples of the number of filament rods (silicon rods) in a reactor are 24 (12 pairs), 36 (18 pairs), 48 (24 pairs), 54 (27 pairs), 72 (36 pairs) or 96 (48 pairs). The silicon rods can to a good approximation be described as cylindrical at all times during the deposition. This is irrespective in particular of whether the filament rods have a cylindrical or for example square design.

After completion of the deposition—generally after a cooldown time—the at least one silicon rod is extracted from the reactor. If silicon rod pairs are involved, the bridge is typically removed after the extraction. The region of the silicon rod via which the latter was connected to the electrodes is also typically removed. An apparatus as described in EP 2 984 033 B1, for example, can be used for the extraction.

If provision is made for comminution, this may be performed by hand, for example with a hammer, or else with a pneumatic chisel. Comminution can be followed by sieving, screening, pneumatic sorting and/or free-fall sorting.

For the generation of the 2D and/or 3D images, the silicon chunks are preferably separated such that these are arranged adjacent to each other. The separation is particularly preferably effected in such a way that the silicon chunks do not touch one another and ideally have a spacing from each other which for example corresponds to the average fragment size of the silicon chunks.

The 2D and/or 3D images are preferably generated on a silicon rod as a whole, the bridge and the region that was connected to the electrodes generally having been removed. However, the silicon rod can also be present broken into a plurality of cylindrical segments. The partial region of which the images are generated may, adjacent to the lateral surface of the silicon rod, also be a fracture surface (approximately cross-sectional area). In particular, images are generated both of the lateral surface and of the fracture surface.

Particularly preferably, 2D and/or 3D images are generated of all silicon rods present in the reaction space.

One or more cameras with appropriate lighting can be used for recording 2D images. The camera can for example be a monochrome or colour camera. It is preferably a digital camera. Both area scan cameras (sensor in the form of an array of pixels) and line scan sensors (with corresponding advancement of the object to be recorded or camera) can be used.

The sensor systems of the camera can generally cover various spectral ranges of light. Cameras for the visible light region are typically used. Cameras for the ultraviolet (UV) and/or infrared (IR) range can also be used. X-ray recordings of the silicon rods or chunks may also be generated. For cameras in the visible light region a recording of the pure greyscale values or else of the colour information (RGB cameras) is possible. Furthermore, special lighting with filtering may also be employed. For example, illumination with a blue light may be performed and the filtering set to precisely this light colour in the pass band. Extraneous light influences can be avoided in this way.

One or else more cameras can be used in principle. If a plurality of images are to be related to each other, it must generally be ensured that the object to be recorded is at rest, at least for the case where the images are being generated in succession. When using a plurality of cameras the images are preferably recorded simultaneously. Should this not be possible, movement of the objects between recordings can usually be corrected using software.

Various sources and various arrangements of these sources can in principle be used for the lighting. Examples of different arrangements are reflected light, dark field, bright field or transmitted light, or else combinations of these. These methods are described, for example, in Handbuch der Bildverarbeitung 2018 [Handbook of image processing 2018], page 49, ISBN: 978-3-9820109-0-8.

Sources of various spectral ranges can generally be used, for example white light, red or blue light, UV light, IR excitation. The sources preferably have minimal possible brightness change (drift) over time. LED lighting can ideally be used. The sources of the various spectral ranges can be flashed in order to increase the short-term intensity. In this case, a flash controller can for example be used to adjust the intensity.

The 2D images are preferably generated under dome lighting. Dome lighting is understood to be a diffuse light incident on the object from all directions equally (Handbuch der Bildverarbeitung 2018, page 51, ISBN: 978-3-9820109-0-8.). This enables homogeneous illumination. It may be preferable here to activate only individual segments of the dome in order to illuminate the object from different directions or viewing angles.

Preferably, at least two, particularly preferably at least three, especially at least four, 2D images are generated, each from a different viewing angle. The individual images are preferably generated simultaneously, that is to say using two, three or four cameras.

According to a further embodiment of the method, at least two, preferably at least three, particularly preferably at least four, 2D images are generated, each under a different illumination. This can for example be ensured by activating a different dome lighting segment for each image. In this way, a separation of surface structure and texture can be realized (Shape from Shading, cf. Handbuch der Bildverarbeitung 2018, page 60, ISBN: 978-3-9820109-0-8.)

A 3D image is on the one hand generally understood to mean images which on a fixed grid (x and y directions) record the height (z direction) as a value for each pixel. On the other hand, however, this is also understood to mean in general 3D point clouds, that is to say a collection of points having x, y and z values without a fixed grid in one of the directions.

The three-dimensional images are preferably generated using a laser as light source.

Preferably, for the generation of three-dimensional images the scattering of a laser point and/or of a laser line on a surface of the chunk or chunks is evaluated.

The 3D images are preferably generated by means of laser triangulation (laser light section method), stripe projection, plenoptic cameras (light field cameras) and/or TOF (time-of-flight) cameras. These methods are described in Handbuch der Bildverarbeitung 2018, page 263-68, ISBN: 978-3-9820109-0-8.

In laser triangulation, a laser line is usually projected onto the object and the image is recorded using an area scan camera which is at a defined angle with respect to the object. Regions of the object which are closer to the camera are imaged further towards the top in the image. An algorithm then determines a height profile from the image. Moving the object or the sensor system (laser and camera) makes it possible to record the 3D surface of the entire object. In general, laser and camera can be arranged freely with respect to each other and can be calibrated via a software combined with defined measurement objects. Integrated sensors which are already precalibrated are also generally available.

Projecting patterns (e.g. striped patterns and modification of the phase) onto the object and recording same via one or more cameras can be used to reconstruct 3D information.

3D recordings of the silicon rods and/or silicon chunks can also be generated by means of (computer) stereo vision. In general, use is made of a plurality of cameras which record the object from various viewing angles. Software (e.g. HALCON, from MVTec) can then be used to relate the images to each other and construct a 3D image.

The silicon rod or the silicon chunks are preferably sent to the generation of the 2D and/or 3D images via a conveyor belt. The conveyor belt in this case in particular has a constant advancing rate. Images are particularly preferably recorded continuously with a running belt, in particular using two or more cameras that are arranged at different positions. For example, images can be generated of a silicon rod continuously or at various positions along its longitudinal axis. However, the conveyor belt can also be stopped for the image generation, if required.

According to a preferred embodiment, dome lighting is arranged above the conveyor belt.

The 2D and/or 3D images can also in addition be generated during free-fall of the silicon chunks. For example, an opening in the dome lighting may be provided, through which the chunks fall and are captured by surrounding cameras. Line scan cameras can preferably be used in this variant.

In addition, a pneumatic sorting installation which sorts the chunks depending on the morphology index determined with the aid of the dome lighting can be arranged downstream of the conveyor belt.

After generating the 2D and/or 3D images, these images are normally subjected to image processing. The image processing may in particular be carried out using a software which is preferably integrated into the system of a process control station. In general, the at least one analysis region per generated image is selected by means of the software.

Based on the analysis region or regions, the surface-structure indices are generated with the aid of various image processing methods. Two, in particular three, different surface-structure indices are preferably generated per analysis region.

The image processing, in particular for determining the analysis region, can involve the following steps:
Processing the image or analysis region using image filters, for example blurring or forming directional derivatives.
Combining various images in order to extract specific information (e.g. shape from shading, that is to say separation of structure and texture).
Segmenting partial regions of the image or analysis region, for example isolation of a silicon chunk from the background, binarization using fixed or dynamic threshold or methods for finding the convex envelope.
Calculating indices (e.g. grey-level co-occurrence matrix (GLCM values or histogram values) for the analysis region.

A first surface-structure index is preferably generated by determination of a grey-level co-occurrence matrix (GLCM) as image processing method. The grey-level co-occurrence matrix describes the neighbourhood relationships of individual greyscale pixels in a particular direction. By combining individual probabilities for the neighbourhood relationships (content of the grey-level co-occurrence matrix), indices can be calculated, for example energy, contrast, homogeneity, entropy. On the basis of this first surface-structure index, conclusions regarding the surface texture (roughness) can be made in particular.

A second surface-structure index is preferably generated using a rank filter, especially median filter, as image processing method. Here, a rank filter is used in order for example to search for local dark spots. The median filter creates a base greyscale value for the environment and the dark spots are assessed relative to this. It is therefore not the absolute greyscale value, but the relative greyscale value with respect to the environment which decides whether a hole or a crack in the surface of the polysilicon is identified.

A third surface-structure index is preferably generated via the image processing method of identification of depressions relative to a convex envelope. First, a region around a depression in the polysilicon is evaluated, for example by assessing a greyscale value gradient (edge drop-off, steepness of the depression). An averaging over all depressions in the analysis region and with this a determination of the average steepness of the holes and trenches is then performed. The dimensions of a depression (e.g. hole or trench) can also be used, that is to say for example width, length, depth, volume, internal surface area to volume.

A fourth surface-structure index can also be generated by the image processing method by determination of the width of a laser line (caused by scattering). This involves structured illumination by means of a laser line and recording with an area scan camera. Usually, the width of the laser line at each point of the silicon surface of the analysis region is determined and a value which correlates to the roughness of the silicon surface is generated. For the calculation of the surface-structure index, an average value is formed in particular over the scatter in the analysis region. On smooth surfaces, the laser line is formed rather fine and narrow, whereas on rough popcorn surfaces it appears rather broader. In addition, in depressions there is reflection from different sides and hence there is also a broadening of the laser line. Ideally, this method can be combined with a conventional laser light section method. In addition to the actual height (3D information), the intensity and the scattering of the line (scatter) at the respective point can for example be determined.

The surface-structure indices obtained for the analysis region are then combined with each other (combined by calculation) to form an (overall) morphology number for the silicon chunk or the silicon rod. A morphology map (heat map) for the analysis region may also be created.

In general, various methods can be used for the combination of the surface-structure indices.

The surface-structure indices obtained are preferably combined to form the morphology index by means of a linear combination.

Further methods that may be used are the formation of decision trees, support vector machine (SVM) regressions or (deep) neural networks.

The morphology index is in particular a dimensionless index, the value of which becomes greater the more fissured/porous and hence the more pronounced the morphology of the polysilicon.

The use of the morphology index for classification offers substantial potential for quality assurance and maximization of productivity. In particular, different types of polysilicon (e.g. polysilicon for electronic semiconductor applications or for solar applications) can be identified and sent in a targeted manner to appropriate further-processing steps on the basis of the morphology index.

For example, very compact polysilicon rods can be classified as suitable for the CZ process and allocated to a corresponding comminution apparatus.

Constant monitoring of the morphology after deposition can also be used to adapt the process regime in order to make the deposition more efficient as a whole.

The further-processing steps can be selected from the group comprising comminution, packaging, sorting (e.g. pneumatic sorting or free-fall sorting), sampling for quality assurance and combinations of these.

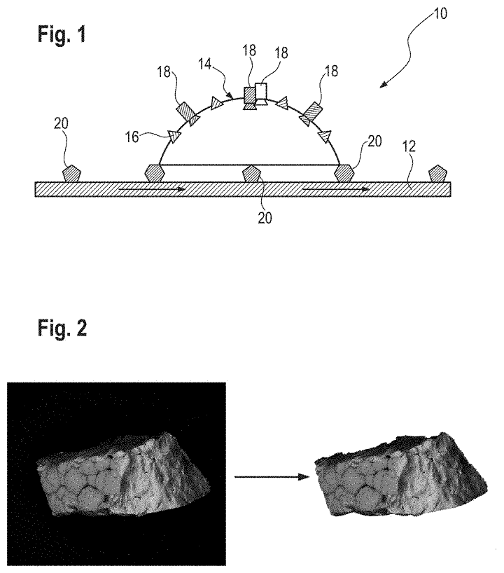

FIG. 1 shows an arrangement for morphology determination after deposition

FIG. 2 shows the segmentation of a polysilicon chunk

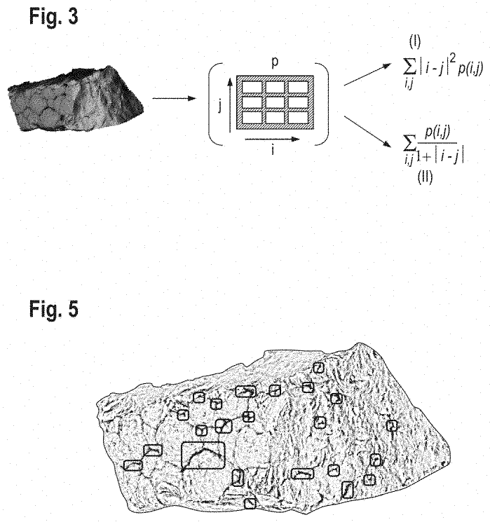

FIG. 3 schematically shows the determination of a surface-structure index on the basis of GLCM

FIG. 4 graphically shows the distribution of the GLCM-based surface-structure indices for different polysilicon types

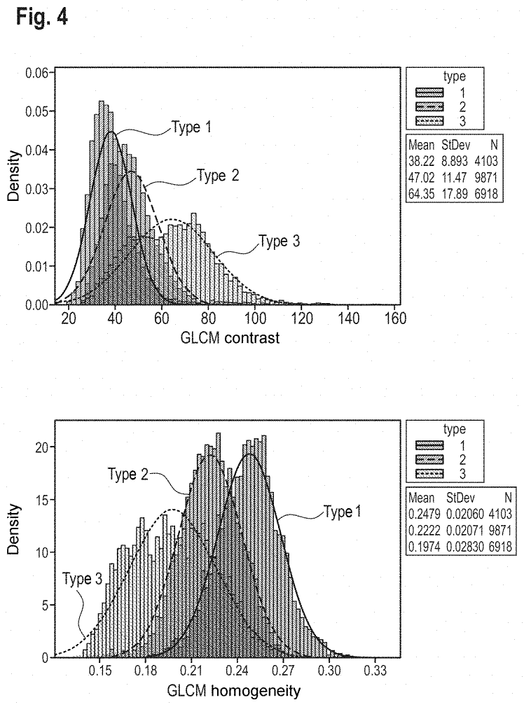

FIG. 5 schematically shows the determination of a surface-structure index on the basis of the identification of depressions

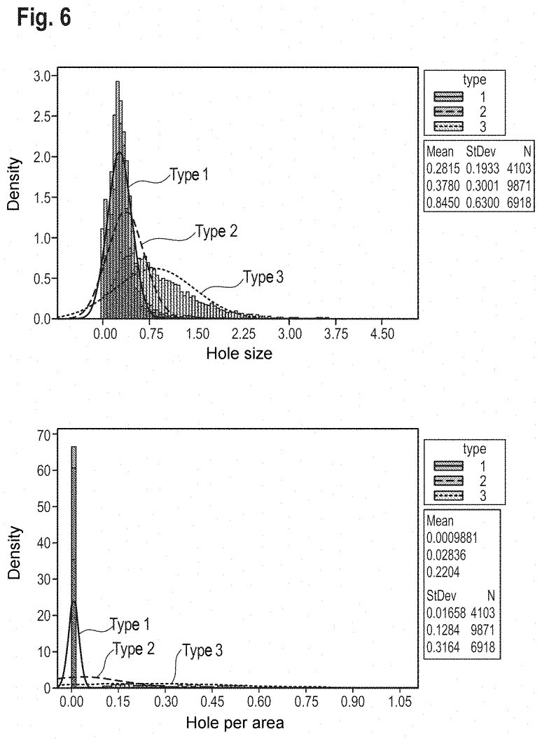

FIG. 6 graphically shows the distribution of the GLCM-based surface-structure indices for different polysilicon types

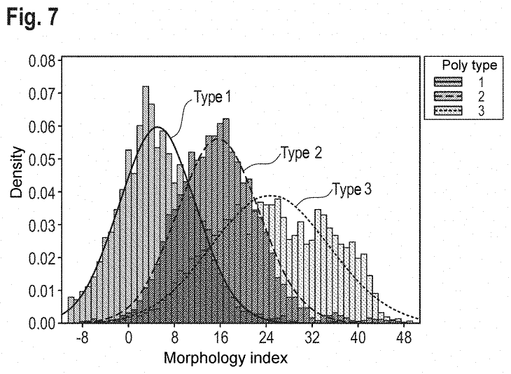

FIG. 7 shows the distribution of the morphology index for different polysilicon types

FIG. 1 shows an arrangement 10, comprising a conveyor belt 12 the advancing direction of which is denoted by two arrows. On the conveyor belt 12 are situated separated polysilicon chunks 20 which are to be classified on the basis of their morphology. Dome lighting 14, which comprises a plurality of cameras 18 and light sources 16, is arranged above the conveyor belt 12. The cameras 18 and light sources 16 are coupled to software and can each be controlled individually. For example, homogeneous light conditions can thus be generated with the light sources 16. However, light incidence from a particular direction can also be produced. For determination of the morphology, one or else more of the chunks 20 are now moved under the dome lighting 14 and 2D images of the chunk or chunks 20 are generated according to the selected imaging setup. The images are preferably generated continuously, that is to say without halting the conveyor belt 12. Using the software, the surface-structure indices are determined from the generated images and are then combined to form a morphology index which is then used for the classification. By way of example, a sorting installation can be arranged at the end of the conveyor belt 12. In principle, a silicon rod can also be moved along its longitudinal axis under the dome lighting 14 on the conveyor belt 12.

### EXAMPLE

Polysilicon rods of three different quality types were produced in a gas phase deposition reactor.

Type 1 is a very compact polysilicon which is destined in particular for the production of semiconductors. There are generally hardly any differences in terms of the morphology between the surface and the interior of the rod.

Type 2 has an intermediate compactness and is used in particular for cost-optimized, robust semiconductor applications and demanding solar applications using monocrystalline silicon.

Type 3 has a high proportion of popcorn. It has a relatively fissured surface and a high porosity. It is used in particular for the production of multicrystalline silicon for solar applications.

A rod of each type was comminuted in each case and the morphology index was determined for each of the chunks using dome lighting as illustrated in FIG. 1. After the comminution, the chunks were first separated on a conveyor belt and moved under dome lighting at a constant speed (advancing rate). The dome lighting was equipped with six area scan cameras at different positions. The 2D images were generated simultaneously from a plurality of viewing angles. A total of six images were recorded per chunk. In the evaluation described hereinafter, for reasons of clarity only one image per chunk (viewing angle perpendicular to the surface of the conveyor belt from above) was subjected to an evaluation, that is to say the morphology index was determined. In total, 4103 chunks of type 1, 9871 of type 2 and 6918 of type 3 polysilicon were examined.

An analysis region was defined for each image by segmentation. FIG. 2 shows by way of example segmentation on the basis of a type-3 polysilicon chunk for the generation of an analysis region. The segmented region, that is to say the analysis region, is illustrated on the right-hand side in FIG. 2.

The segmentation of the chunk is carried out by the following steps: (1) Applying a filter (blur) to the entire image region, in order to smooth hard edges.

(2) Applying a further filter (Sobel filter, direction-independent) for calculating the brightness differences.

(3) Segmenting the chunk from the outside inwards by identifying the region having a brightness difference greater than a defined threshold. This involves iteratively discarding regions having too low a brightness difference starting from the outside until only the relevant region (cf. FIG. 2, right-hand side) still remains as analysis region.

From this analysis region were generated a first surface-structure index by determination of the grey-level co-occurrence matrix (GLCM values) and a second surface-structure index by identification and assessment of depressions.

The scheme for calculation of the GLCM values is illustrated in FIG. 3.

The GLCM (grey-level co-occurrence matrix) is determined by counting combinations of greyscale values. An entry is made in the GLCM for each pixel in the analysis region, where i is the greyscale value of the pixel itself and j is the greyscale value of the pixel in the vicinity. Since a pixel in a typical 2D image has 8 neighbouring pixels, it is usual to determine the GLCM for all directions and to take the average of these. It is also possible not to use immediate neighbouring values, but to use the neighbouring value at a distance of n pixels. The immediate neighbours were used in the example. Division by the sum total of the matrix entries is then typically performed. The values then correspond to a probability p for the particular greyscale value combination.

Consideration of the contrast (equation (I)): For this purpose, high contrasts (i.e. large differences in the greyscale values) are provided with a high weighting. The term |i−j|² from equation (I) is then large when the values are as remote as possible from the main diagonals. These are the values at which i and j are maximally different, that is to say the greyscale values are maximally different.

Consideration of the homogeneity (equation (II)): Here there is division by the term 1+|i−j|. Values close to the main diagonals are therefore weighted more heavily. As a result, regions having very similar greyscale value ranges are given a higher value in this index. Two surface-structure indices are thus obtained in principle by the equations (I) and (II).

It can be recognized from the graphical evaluation shown in FIG. 4 of the GLCM indices for the three different polysilicon types that the values obtained for homogeneity and contrast are opposed. The distribution of the indices for the individual polysilicon types is illustrated in the histograms. The values on the X axis correspond to the values for the respective index. The density concerns the relative frequencies for the occurrence of the particular value.

The generation of the second surface-structure index on the bases of the identification and assessment of depressions is schematically shown in FIG. 5, with on the one hand the number of holes per area and on the other hand the hole size as an average greyscale value gradient at the edge of the hole having been determined. A median filter is used to present the depressions relative to their surroundings. This makes it possible to subsequently find and mark the regions having a value less than a defined threshold and a defined minimum size in pixels (cf. the rectangles of different sizes).

The evaluation for the second surface-structure indices is illustrated in FIG. 6. Here, the hole regions in the analysis region are counted and output relative to the pixel area. For type 1 (very compact), only very few holes are present, that is to say the index has a value close to zero. Somewhat more holes are present for type 2. Type 3 (fissured) has a recognizable distribution of holes (cf. FIG. 6, bottom). For an assessment of the holes, the hole size is considered as an average gradient at the edge of the hole (greyscale value drop-off), the values being scaled. For type 1, this is lower since the holes present are less deep and pronounced and therefore do not appear as dark. For type 2 and type 3, the hole regions are more strongly pronounced (steeper and thus darker), and as a result the value for the index rises.

The surface-structure indices determined are combined with each other (combined by calculation) in a final step in order to obtain a morphology index which can be used as a basis for subjecting the relevant polysilicon chunk for example to a sorting (i.e. classification). This combination is effected by means of a linear combination using the following equation

yⱼ=Σᵢ₌₁^{N}aᵢ*(x_{j,i}−bᵢ),

where
x_{j,i}=ith index of the jth chunk
aᵢ=gradient for the ith index
bᵢ=base value for the ith index
yⱼ=morphology value of the jth chunk.

The result of the linear combination is shown in FIG. 7 using the histogram. The resulting distributions differ significantly, and accordingly the three different polysilicon types are distinguishable from each other. The combination of a plurality of indices makes the method more robust and more independent of individual outliers.

1-13. (canceled)

14. A method for producing and classifying polycrystalline silicon, comprising:
producing a polycrystalline silicon rod by introducing a reaction gas, which in addition to hydrogen contains silane and/or at least one halosilane, into a reaction space of a gas phase deposition reactor, wherein the reaction space contains at least one heated filament rod upon which silicon is deposited to form the polycrystalline silicon rod;
extracting the polycrystalline silicon rod from the reactor;
optionally comminuting the polycrystalline silicon rod to obtain silicon chunks;
generating at least one two-dimensional and/or three-dimensional image of at least one partial region of the polycrystalline silicon rod or of at least one silicon chunk, and selecting at least one analysis region per generated image;
generating at least two surface-structure indices per analysis region by using image processing methods, each surface-structure index being generated using a different image processing method;
combining the surface-structure indices to form a morphology index; and
wherein the image processing methods are selected from the group comprising determination of a grey-level co-occurrence matrix, use of a rank filter, identification of depressions relative to a convex envelope and determination of the width of a laser line, and wherein the polycrystalline silicon rods or the silicon chunks are classified depending on the morphology index and are sent to different further-processing steps.

15. The method of claim 14, wherein the two-dimensional images are generated under dome lighting.

16. The method of claim 14, wherein at least two, preferably at least three, particularly preferably at least four, two-dimensional images are generated, each from a different viewing angle.

17. The method of claim 14, wherein at least two, preferably at least three, particularly preferably at least four, two-dimensional images are generated, each under a different illumination.

18. The method of claim 14, wherein the three-dimensional images are generated using a laser as light source.

19. The method of claim 14, wherein the three-dimensional images are generated by scattering a laser point and/or by a laser line on a surface of the chunks that is being evaluated.

20. The method of claim 14, wherein the three-dimensional images are generated by using laser triangulation and/or stripe-light projection.

21. The method of claim 14, wherein the polycrystalline silicon rod or the silicon chunks are sent to the generation of the two-dimensional or three-dimensional images via a conveyor belt.

22. The method of claim 14, wherein the rank filter is a median filter.

23. The method of claim 14, wherein the surface-structure indices are combined to form the morphology index by using a linear combination, a support vector machine, regressions or artificial neural networks.

24. The method of claim 14, wherein the further-processing steps are selected from the group comprising comminution, packaging, sorting, sampling for quality assurance and combinations of these.
